(19) United States
(12) Patent Application Publication
(10) Pub. No.: US 2015/0169557 A1
(43) Pub. Date: Jun. 18, 2015

(54) RECOMMENDING CONTENT ITEMS

(71) Applicants: Calin Ciordas, Hoofddorp (NL); Andrew Augustine Wajs, Hoofddorp (NL)

(72) Inventors: Calin Ciordas, Hoofddorp (NL); Andrew Augustine Wajs, Hoofddorp (NL)

(73) Assignee: IRDETO B.V., Hoofddorp (NL)

(21) Appl. No.: 14/387,508

(22) PCT Filed: Mar. 23, 2012
(86) PCT No.: PCT/EP2012/055254

§ 371 Date: Mar. 4, 2015

(51) Int. Cl. G06F 17/30; H04N 21/466; H04N 21/482; G06Q 30/06

(52) U.S. Cl. CPC G06F 17/3002; G06Q 30/0631; H04N 21/4668; H04N 21/4826

(57) ABSTRACT

A method of maintaining a list of recommended content items, the method comprising: receiving content list data, the content list data identifying a plurality of content items and comprising relationship data that identifies, for each of one of more of the plurality of content items, an associated set of one or more other content items in the plurality of content items; storing a current list of recommended content items; receiving an identification of a content item in the plurality of content items that has been selected by a user; and forming an updated list of recommended content items based on (a) the current list of recommended content items, (b) the selected content item and (c) the content list data.

### RELATED APPLICATION DATA

This application is the National Stage of International Patent Application No. PCT/EP2012/055254, filed Mar. 23, 2012, the disclosure of which is hereby incorporated by reference in its entirety.

### FIELD OF THE INVENTION

This invention relates to a method of maintaining a list of recommended content items, and an apparatus and computer program for carrying out the same.

### BACKGROUND OF THE INVENTION

It is know for content items to be made available to end users (or their computing devices). Such content items may each be any amount of data, media, multimedia or other content or information which the user can experience, for example, the content items might be video (such as television programmes or movies), audio (such as music or radio programmes), graphical (such as photographs or other images), textual, etc. Given the plethora of content items that are now available (for example, due to the ever increasing number of broadcast television channels), it is desirable to be able to provide the end users with recommendations for particular content items—in this way, the end users do not need waste time trying out a large number of content items before finding one that they are interested in and will enjoy. The end user's devices are, however, often low powered, with low amounts of memory and/or processing capabilities, and do not always have a back-channel to the providers of the content items. It would, therefore be desirable, to provide a recommendation system suitable for such a scenario.

### SUMMARY OF THE INVENTION

According to a first aspect of the invention, there is provided a method of maintaining a list of recommended content items, the method comprising receiving content list data, the content list data identifying a plurality of content items and comprising relationship data that identifies, for each of one of more of the plurality of content items, an associated set of one or more other content items in the plurality of content items; storing a current list of recommended content items; receiving an identification of a content item in the plurality of content items that has been selected by a user; and forming an updated list of recommended content items based on (a) the current list of recommended content items, (b) the selected content item and (c) the content list data.

Updating the recommended content list in the manner set out above is well-suited to low powered devices that may have low amounts of memory and/or low processing capabilities. Additionally, such a method of updating the recommended content list does not need a back-channel to the providers of the content items or the content list data.

In some embodiments, for each of the one of more of the plurality of content items having an associated set, the associated set is an ordered set. For each of the one of more of the plurality of content items having an associated set, the relationship data may comprise, for each of the one or more other content items in that associated set, a respective weight, the associated set being ordered based on said weights. The weight for a first content item in a set associated with a second content item may represent a likelihood that the user will be interested in the first content item if the user is interested in the second content item.

In some embodiments, each content item identified in the set associated with a given content item is similar to the given content item or related to the given content item.

In some embodiments, the current list of recommended content items is an ordered list.

In some embodiments, for each of the one of more of the plurality of content items having an associated set, the number of content items in the associated set is at most a predetermined maximum number of content items.

In some embodiments, the current list of recommended content items is initially an empty list, and forming an updated list of recommended content items comprises setting the current list of recommended content items to identify one or more of the content items identified by the set associated with the selected content item.

In some embodiments, forming an updated list of recommended content items is based on a function of the content items in the current list of content items and the one or more content items identified by the set associated with the selected content item.

In some embodiments, the function selects a first number of content items from the current list of content items and a second number of content items from the set associated with the selected content item.

In some embodiments, the first number of content items are content items occurring at the start of the ordered current list of content items and the second number of content items are content items occurring at the start of the ordered set associated with the selected content item. The updated list of recommended content items may be ordered based on the ordering of the first number of content items from the ordered current list of content items and the ordering of the second number of content items from the ordered set associated with the selected content item. The position, in the ordered list of recommended content items, of a content item may be modified if that content item appears in both the current list of content items and the set associated with the selected content item.

In some embodiments, the function selects a content item for inclusion in the updated list of recommended content items if that content item appears in both the current list of content items and the set associated with the selected content item.

In some embodiments, the content item data identifies, for each content item, a respective time at which that content item is available to be experienced by the user, the updated list of recommended content items being formed in dependence upon the respective times at which the content items are available to be experienced by the user. The function may select content items for inclusion in the updated list of recommended content items so that the respective times at which the content items in the updated list of recommended content items are available to be experienced by the user are substantially evenly distributed over time. The function may order content items in the updated list of recommended content items in dependence upon the respective times at which the content items in the updated list of recommended content items are available to be experienced by the user.

In some embodiments, the content list data identifies an update to an identified plurality of content items and/or relationship data identified by previously received content list data, the method then comprising updating the identified plurality of content items and/or relationship data based on the update

In some embodiments, the method comprises receiving an update to the identified plurality of content items and/or to the relationship data, and, in response to receiving the update, updating the current list of recommended content items based on the received update.

According to an aspect of the invention, there is provided an apparatus arranged to carry out any one of the above-described methods.

According to an aspect of the invention, there is provided a computer program which, when executed by a processor, causes the processor to carry out any one of the above-described methods. The computer program may be stored on a computer readable medium.

### BRIEF DESCRIPTION OF THE DRAWINGS

Embodiments of the invention will now be described, by way of example only, with reference to the accompanying drawings, in which:\

FIG. 1 schematically illustrates a system according to an embodiment of the invention;

FIG. 2 schematically illustrates content list data according to an embodiment of the invention;

FIG. 3 schematically illustrates a method of maintaining a list of recommended content items according to an embodiment of the invention; and

FIG. 4 schematically illustrates updated content list data according to an embodiment of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

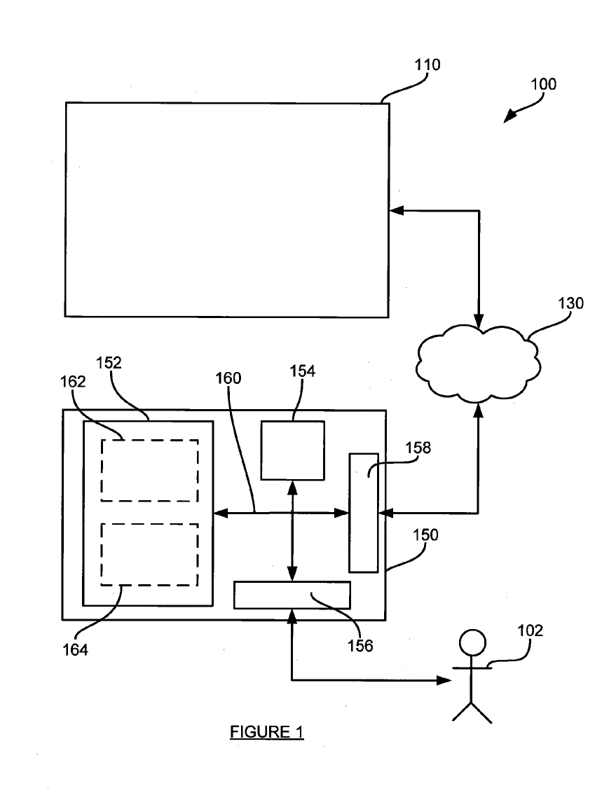

FIG. 1 schematically illustrates a system 100 according to an embodiment of the invention. The system comprises a sender 110 that is arranged to communicate with a receiver 150 via a network 130.

The network 130 may be any kind of network suitable for transmitting or communicating data from the sender 110 to the receiver 150. For example, the network could comprise one or more of a local area network, a wide area network, a metropolitan area network, the internet, a wireless communications network, a cable network, a digital broadcast network, a satellite communication network, a telephone network, etc. The sender 110 may then communicate with the receiver 150 over the network 130 via any suitable communication mechanism/protocol in order to communicate data from the sender 110 to the receiver 150.

The receiver 150 comprises a memory 152, a processor 154, a user input and output interface 156, and a network interface 158, which are all linked together via one or more communication buses 160.

The memory 152 may be any random access memory (storage unit or volatile storage medium), suitable for storing data and/or computer programs (or software or instructions or code) that form part of an embodiment of the invention. As will be described in more detail shortly, the memory 152 is arranged to store a list of recommended content items 162 and content list data 164.

The processor 154 may be any data processing unit suitable for executing one or more computer programs (such as those stored in the memory 152) which have instructions that, when executed by the processor 152, cause the processor 152 to carry out a method according to an embodiment of the invention and configure the receiver 150 to be a receiver according to an embodiment of the invention. The processor 154 may comprise a single data processing unit or multiple data processing units operating in parallel or in cooperation with each other. The processor 154, in carrying out data processing operations for embodiments of the invention may store data to and/or read data from the memory 152.

The user input and output interface 156 is arranged to receive one or more inputs from a user (or operator) 102 of the receiver 150. In some embodiments of the invention (such as where the receiver 150 is a personal computer), the user input and output interface 156 may receive input from the user 102 via the user 102 operating one or more input devices communicatively coupled to the receiver 150, such as a mouse (or other pointing device), a keyboard, a touchscreen, etc. In other embodiments of the invention (such as where the receiver 150 is a set top box or a television set), the user input and output interface 156 may receive input from the user 102 via the user 102 operating a remote control unit associated with the receiver 150 or one or more buttons on the receiver 150. Input received from the user 102 via the user input and output interface 156 may be passed to the processor 154 for processing and/or may be stored in the memory 152 for subsequent processing by the processor 154.

The user input and output interface 156 may also be arranged to provide one or more outputs to the user 102. This output may be an audio output, in which case the user input and output interface 156 may be arranged to provide an audio signal to one or more speakers. Additionally or alternatively, this output may be a video/image output, in which case the user input and output interface 156 may be arranged to provide a video/image signal to a display (or screen or monitor).

The network interface 158 is arranged to interface with the network 130 so that the receiver 150 can then receive data from the sender 110 via the network 130. Data received at the receiver 150 via the network 130 may be passed to the processor 154 for processing and/or may be stored in the memory 152 for subsequent processing by the processor 154.

As examples, the receiver 150 may comprise one or more of a set-top-box, a personal computer, a mobile telephone, a games console, a television set with integrated functionality, etc., but it will be appreciated that the receiver 150 may take other forms instead.

The sender 110 may be any system capable of communicating data to the receiver 150 via the network 130. For example, the sender 110 may comprise one or more server computers for providing data to the receiver 150. Additionally, or alternatively, the sender 110 may be arranged to broadcast data, for example via a satellite communication network 130, with the receiver 150 then be arranged to receive such broadcast data 110.

In one particular embodiment, the sender 110 may be a head-end of a digital television broadcast system or of a cable television system. The network 130 may then comprise one or more of a cable network, a terrestrial broadcast network and a satellite communications network. The receiver 150 may then be a set top box, a television set, a digital video recorder, or any other device arranged to receive television signals and associated information signals from the sender 110.

As an overview, the receiver 150 is arranged to receive content list data 164 from the sender 110 via the network 110. The content list data 164 comprises information concerning one or more content items. The receiver 150 is arranged to generate and update the list of recommended content items 162. This generation and updating is based on the current list of recommended content items 162, the received content list data 164, and an input from the user 102 (in particular, a selection or indication of a particular content item). This is described in more detail below.

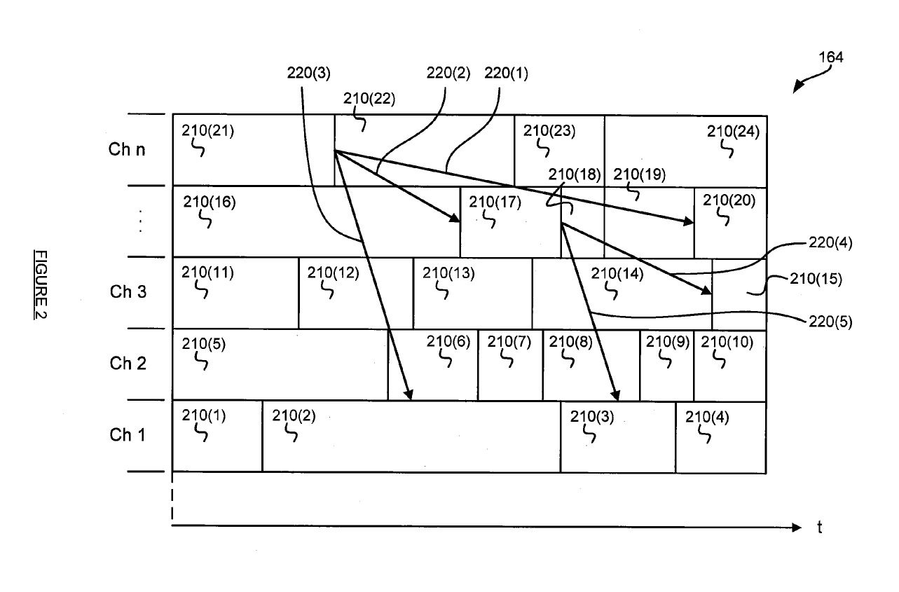

FIG. 2 schematically illustrates the content list data 164 according to an embodiment of the invention. The content list data 164 comprises data identifying a plurality of content items 210. The content list data 164 also comprises relationship data. The relationship data may identify one or more relationships 220 between one or more of the plurality of content items 210 and one or more other content items 210. Put another way, for each of one or more of the plurality of content items 210, the relationship data may identify an associated set of one or more other content items 210 in the plurality of content items 210.

The content items 210 may each be any amount of data, media, multimedia or other content or information which the user 102 can experience. As examples, the content items 210 might be video (such as television programmes or movies), audio (such as music or radio programmes), graphical (such as photographs or other images), textual, etc.

The content list data 164 may identify, for one or more of the content items 210, a respective associated channel (depicted as “Ch 1”, “Ch2”, “Ch 3”, . . . , “Ch n” in FIG. 2) via which that content item 210 may be accessed. These channels might be physical, logical or virtual channels or any combination thereof. As examples, such channels might be the physical or logical channels in a television or radio broadcast system, multiplexed channels in a distribution system, a uniform resource identifier (URI), a web address, etc.

The content list data 164 may identify, for one or more of the content items 210, a respective time at which that content item 210 is available (and can therefore be accessed and/or experienced by the user 102). This time may be indicated by a point in time (e.g. a start time after which the content item 210 is available), a duration/period of time (e.g. a start time and an end time, or a start time and a length of the period), etc.

The content list data 164 may store other information or metadata to identify and/or describe the content items 210, such as a title, summary, rating, etc.

In this way, in some embodiments of the invention the content list data 164 may comprise data for an electronic program guide (EPG) and/or a list of content items 210 available for on-demand access (such as a list of available video-on-demand programmes). It will be appreciated that these are merely examples.

Each relationship 220 (as defined by the relationship data of the content list data 164) is a respective association of one of the content items 210 identified by the content list data 164 with another one of the content items 210 identified by the content list data 164. Preferably, as the intention is to recommend one or more content items 210 to the user 102, a relationship 220 between two content items 210 indicates that there is a likelihood that the user 102 will enjoy or appreciate one of the two content items 210 if the user 102 enjoys or appreciates the other one of the two content items 210. Thus, a relationship 220 between two content items 210 indicates that those two content items are similar or related to each other somehow.

The relationships 220 may be determined by the sender 110 or by some other entity that provides data defining the relationships 220 to the sender 110.

The relationships 220 may be determined via an assessment of similarity between the respective content items 210. As an example, such determination might be achieved via manual evaluation, automated evaluation, assessment of user feedback, or with reference to other sources of information that are suitable for making such a determination, or any combination of these techniques.

The relationships 220 may be determined based on a categorisation of the content items 210, with two content items 210 being associated with each other via a relationship 220 if they have one or more categories in common. The categorisation can be any kind of categorisation that can be applied to a content item 210, for example, the type of the content item 210, the genre of the content item 210, or a grouping of content items 210 to which that content item 210 is a member. As examples, a content item 210 might be categorised as a video type content item 210 and further categorised as being in one or more genres such as sports, news, documentaries, movies, television series, cartoons, music shows, live performance events and so on—thus, a relationship 220 might be defined between content items 210 having the same category (for example, two “news” video content items 210 may have a relationship 220 defined to link them). A content item 210 that is an episode of a particular series of content items 210 might be grouped, for example, into the same group as the other episodes of that particular series of content items 210—thus, a relationship 220 might be defined between different episodes or members of a series of content items 210.

The relationships 220 may be determined based on metadata associated with the content items 210. For example the metadata associated with the content items 210 may specify an author, director, actor, location, genre, etc., and two content items 210 that share similar or the same details for some or all of this type of metadata may be considered to be sufficiently similar to warrant a relationship 220 being defined between those content items 210. For example, if two content items 210 have the same “lead actor”, then this may be considered to be sufficiently similar to warrant a relationship 220 between those two content items 210.

The content list data 164 may specify a relationship 220 by storing a pair of identifiers of content items 210. For example, in FIG. 2, the content item 210(22) has a relationship 220(2) with the content item 210(17)—in this case, the content list data 164 may specify the relationship 220(2) by storing the identifiers “22” and “17” together as a pair. Alternatively, the content list data 164 may specify a relationship 220 by storing, in association with a first content item 210 involved in the relationship 220, an identifier of a second content item 210 involved in the relationship 220 (e.g. as metadata associated with the first content item 210). It will be appreciated that other ways of specifying the relationships 220 as relationship data within the content list data 164 are possible.

Thus, in general, for one or more of the content items 210, there is an associated set (or list or group) of one or more other content items 210, and the relationship data of the content list data 164 may identify or indicate that associated set of other content items. These other content items 210 in the set associated with a given content item 210 are content items 210 that have a relationship 220 with that given content item 210. For example, in FIG. 2, (a) the content item 210(22) has relationships 220(1), 220(2), 220(3) with content items 210(20), 210(17), 210(2) respectively, so that the set associated with the content item 210(22) is a set identifying content items 210(20), 210(17), 210(2), e.g. the set of identifiers {“20”, “17”, “2”}; and (b) the content item 210(18) has relationships 220(4), 220(5) with content items 210(15), 210(3) respectively, so that the set associated with the content item 210(18) is a set identifying content items 210(15), 210(3), e.g. the set of identifiers {“15”, “3”}.

The content list data 164 may identify an order for the relationships 220 based on the degree of similarity between the content items 210 identified by the relationship. For example, the higher a relationship 220 between two content items is in the ordering, then the higher the likelihood that the user 102 will enjoy or appreciate one of the two content items 210 if the user 102 enjoys or appreciates the other of the two content items 210. Analogously, then, the set of content items 210 associated with a content item 210 (as identified by the relationship data) may be an ordered set. This ordering may be based on the degree of similarity of the content items in the set. For example, the set of identifiers {“20”, “17”, “2”} associated with the content item 210(22) may be ordered such that the content item 210(20) is higher in the order than the content item 210(2), and the content item 210(2) is higher in the order than the content item 210(17), i.e. the identifiers are in the order “20”>“2”>“17”. This may indicate that a user interested in the content item 210(22) is more likely to be interested in the content item 210(20) than he is in the content item 210(2), and is more likely to be interested in the content item 210(2) than he is in the content item 210(17).

The relationship data of the content list data 164 may associate or specify a respective value or weight with each relationship 220. These weights may therefore define an order for the relationships 220 associated with a given content item 210, i.e. these weights may define an ordering for the set associated with a given content item 210. The weight for a relationship 220 may represent a measure or degree of similarity between the content items 210 linked by that relationship 220. The weight for a first content item 210 in a set associated with a second content item 210 may represents a likelihood (or a degree or measure of a probability) that the user 102 will be interested in the first content item 210 if the user is interested in the second content item 210. Then, the higher the weight or similarity measure specified for a relationship 220 between two content items 210, the higher the likelihood that the user 102 will enjoy or appreciate one of the two content items 210 if the user 102 enjoys or appreciates the other of the two content items 210. For example, the set of identifiers associated with the content item 210(22) may be {(“20”, 0.8), (“17”, 0.25), (“2”, 0.45)}, where the identifier “20” has a weight value of 0.8, the identifier “17” has a weight value of 0.25 and the identifier “2” has a weight value of 0.45, which then defines the ordering “20”>“2”>“17” (because 0.8>0.45>0.25).

The content list data 164 may be formed such that the number or relationships 220 identified for each content item 210 is limited to a (predetermined) maximum number of relationships 220, thereby reducing and/or limiting the amount of data required to transmit or store the content list data 164. Where the content list data 164 is formed with a maximum number of relationships 220 per content item 210, the relationships 220 that are identified by the content list data 164 might relate to those relationships 220 with higher levels of associated similarity. Thus, for each of the content items 210 that has an identified associated set of other content items 210, the number of content items 210 identified in the associated set may be at most a predetermined maximum number of content items 210.

Where the content list data 164 associates some or all of the content items 210 with a respective time at which that content item 210 is available, the relationship data might only specify relationships 220 involving a content item 210 that is currently available or that will be available in the future, or both.

Where the content list data 164 associates some or all of the content items 210 with a respective channel via which the content item 210 may be accessed, the relationship data might only specify relationships 220 between content items 210 within one or a subset of the channels, and/or might only specify a relationship 220 between two content items 210 if those two content items 210 occur in the same channel.

As an example, the content list data 164 might identify content items 210 which are to be broadcast on a schedule, such as broadcast television or radio programmes. In such a case, the content list data 164 might identify a point in time at which each content item 210 is available. The content list data 164 might also identify a channel, such as a television or radio channel, on which each content item 210 will be available. With reference to the example shown in FIG. 2, the content list data 164 can identify that the content item 210(1) is available on channel ‘Ch 1’ and is followed by the content item 210(2), and that the content item 210(5) is available on channel ‘Ch 2’ at the same time as the content item 210(1) is available on channel ‘Ch 1’. In this example, the relationship data might only contain relationships for content items 210 that are either currently available or will be available in the future. If content item 210(21) were to be an action movie, the relationship data might identify relationships 220 based on the categorisation of the content item as “action” and might therefore, for example, relate the content item 210(21) to another action movie 210(2), or to an episode of a TV series 210(17) which is also categorised as being an “action” series. Similarly, the content item 210(22) may have a relationship 220(1) with the content item 210(20) if these two content items 210(22), 210(20) involve one or more of the same actors or directors. It will be appreciated that this is merely exemplary and that relationships 220 may be defined based on other criteria.

Whilst the content list data 164 is illustrated in FIG. 2 with each content item 210 being associated with a respective point in time at which the content item 210 is available and a respective channel via which it may be accessed, it will be appreciated that embodiments of the invention might only associate content items 210 with just one of a respective point in time at which they are available or a respective channel via which they can be accessed, or neither of these.

As an example, the content list data 164 might identify content items 210 which are available on demand. As such, the content items 210 might not be associated with any particular period of time during which they are available or a particular channel. Some of the content items 210 might be associated with a period of time during which they are available, for example, some on demand content items 210 might only be available for on demand access for a certain period of time, or the content list data 164 might contain a mix of scheduled content items 210 and on-demand content items 210.

In some embodiments, the data identifying the content items 210 may be received at the receiver 150 together with the relationship data, i.e. the content list data 164 may be received all together as a single unit. However, it will be appreciated that the data identifying the content items 210 may be received at the receiver 150 separately from the relationship data. It will also be appreciated that the content list data 164 may be received separately from the content items 210 themselves. For example, the content list data 164 may be transmitted to the receiver 150 as a data stream, with the content items 210 being available via one or more other data streams (which may or may not be multiplexed with the data stream for the content list data 164, e.g. as one combined transport stream).

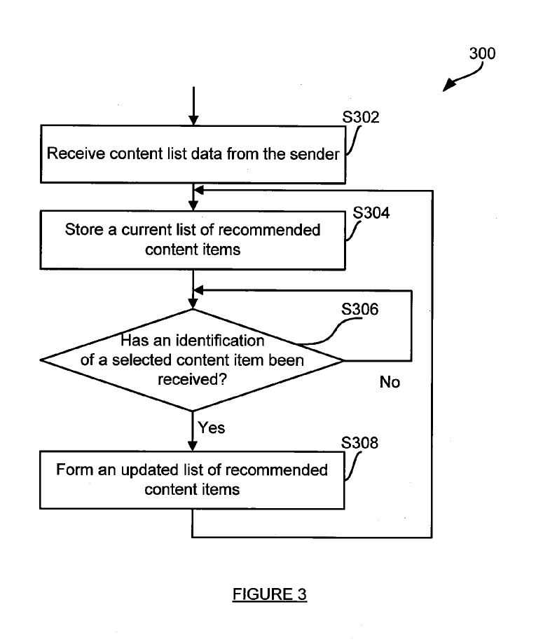

FIG. 3 schematically illustrates a method 300 of maintaining a list of recommended content items according to an embodiment of the invention. The method 300 is carried out by the processor 154 of the receiver 150.

At a step S302, the receiver 150 receives content list data 164. The content list data 164 is sent by the sender 110 across the network 130 and received by the receiver 150 at the network interface 158. The received content list data 164 may then be passed to the processor 154 for processing and/or may be stored in the memory 152 for subsequent processing by the processor 154. The sender 110 may send the content list data 164 to the receiver 150 periodically/regularly, intermittently, at irregular points in time, or continuously (e.g. as a continuous stream of data).

At a step S304, the receiver 150 stores a current list of recommended content items 162. The current list of recommended content items 162 is stored in the memory 152 by the processor 154.

The list of recommended content items 162 identifies one or more, or potentially zero (e.g. when the list of recommended content items 162 is to be first generated), content items 210 which are determined as being suitable for being recommended to the user 102. Methods by which this determination is made will be set out in more detail shortly.

The list of recommended content items 162 may be an ordered list. This ordering may be based on respective degrees or levels of suitability for recommendation of the content items 210 identified in the list of recommended content items 162. In particular, the ordering of the list of recommended content items 162 may be based, in whole or in part, on the likelihood that a content item 210 is of interest to the user 102. Additionally or alternatively, the ordering of the list of recommended content items 162 may be based, in whole or in part, on other metadata associated with the content items 210. As an example, the ordering may be based, in whole or in part, on metadata which indicates how current the content items 210 are: for instance newer (or more recently released) content items 210 may be prioritised over (or ordered higher than) older content items 210. As a further example, the ordering may be based, in whole or in part, on metadata which indicates an advertisement value of the content item 210: for instance, content items 210 with a higher advertisement value may be prioritised over (or ordered higher than) content items 210 with a lower advertisement value. It will be appreciated that any kind of metadata might be associated with the content items 210 and used as the basis for ordering the list of recommended content items 162.

The list of recommended content items 162 may be limited such that a maximum number of content items are identified in the list of recommended content items 162. In particular, the list of recommended content items 162 that is generated and stored may be limited so as to identify at most a predetermined number, S, of content items 210.

The list of recommended content items 162 that is stored at the step S304 may be one that is generated based on an existing/previous list of recommended content items, such as one that is generated in a step S308, which is described in more detail below. However, the list of recommended content items 162 that is stored at the step S304 may be one that is generated to create a new list of recommended content items 162. This may be achieved in a number of ways, for example, creating an empty list, creating a list that is populated with a random selection of content items from the content list data 164, obtaining indications from a user indicating content items 210 or types of content item 210 which are of interest and using these indications to populate the list with appropriate/matching content items 210 selected from the content list data 164, and so on. It will be appreciated that any method of generating a new list of recommended content items 162 may be used. Thus, at a step S304, it is assumed that the receiver 150 stores a current list of recommended content items 162.

At a step S306, the receiver 150 receives an identification of a content item 210, out of the content items 210 identified by the content list data 164, that the user 102 has selected. The identification of a selected content item is received from the user 102 at the user input and output interface 156.

The identification of a selected content item 210 may represent the user's interest in that particular content item 210. The user's interest may be indicated in any number of ways, such as one or more of: the user 102 selecting to experience (e.g. watch or listen to) a content item 210; the user 102 selecting to record a content item 210; the user 102 providing a favourable rating for a content item 210; the user 102 selecting to bookmark a content item 210; the user 102 selecting to receive a reminder about a content item 210; determining that a user 102 has selected a content item 210 if the receiver 150 remains tuned to that content item 210 for over a predetermined amount of time (e.g. to distinguish between a user 102 that is channel-hopping and a user that has selected a specific channel); etc. It will be appreciated that any means of indicating the user's interest in a content item 210 may be used.

The selection of a content item 210 may be carried out, for example, from an EPG displayed to the user 102.

It will be appreciated that a user 102 may select a content item 210 in a variety of ways, such as by entering a selection of a content item 210 via a remote control or other input device associated with the receiver 150.

At a step S308, the receiver 150 forms or produces an updated list of recommended content items 162. The updated list of recommended content items 162 is generated by the processor 154 based on (or with reference to or as a function of): (a) the current list of recommended content items 162 (as stored at the step S304), (b) the selected content item 210 (as selected at the step S306) and (c) the content list data 164 (as received at the step S302).

The updated list of recommended content items 162 may be formed based on a function, f, of the content items 210 identified in the current list of recommended content items 162 and the one or more content items 210 identified by the set associated with the selected content item 210, as set out in the relationship data. The function f selects or identifies content items 210 for inclusion in the updated list of recommended content items 210.

In the following examples, we assume that: (a) the current list of recommended content items 162 (as stored at the step S304) is {I^{R}₁, I^{R}₂, . . . , I^{R}ₙ}, (b) the selected content item 210 (as selected at the step S306) is content item I_{T} and (c) the identified set of content items 210 associated with the selected content item I_{T} is {I^{T}₁, I^{T}₂, . . . , I^{T}_{mT}}, where each I^{R}ᵢ (i=1, . . . , n) is (or identifies) one of the content items 210 and also where each I^{T}ᵢ (i=1, . . . , M) is (or identifies) one of the content items 210. Here, the value of m may depend on the particular selected content item I_{T}—although in some embodiments m may be constant.

The function f may form the new or updated list of recommended content items 162 by selecting a first number N1 of content items 210 from the current list of recommended content items 162 and a second number N2 of content items 210 from the set associated with the selected content item I_{T}—the updated list of recommended content items 162 then comprises, or identifies, the selected N1 and N2 content items 210. Here, N1 and N2 are integers with N1 and NM). For example, all of the content items 210 from the current list of recommended content items 162 may be selected (so that N1=n) and all content items 210 from the set associated with the selected content item I_{T} may be selected (so that N2=m). However, in some embodiments, N1 may be less than n and/or N2 may be less than m. In some embodiments N1 may be set to be equal (or at least substantially equal) to N2. Additionally, in some embodiments the number of content items 210 identified by the list of recommended content items 162 may be limited to a predetermined maximum number S of content items 210, in which case N1 and N2 are chosen such that N1+N2S; in particular, if n+m>S, then N1 and N2 may be chosen such that N1+N2=S (perhaps setting N1=N2=½S).

The selection of the N1 content items 210 from the current list of recommended content items 162 may be a random selection. However, if the current list of recommended content items 162 is ordered, the first number N1 of content items 210 that are selected from that list may be those content items 210 which occur at the start of the ordered list. For example, if the current list of recommended content items 162 (as stored at the step S304) is {I^{R}₁, I^{R}₂, . . . , I^{R}ₙ} and is ordered such that I^{R}ᵢ occurs in the ordering prior to I^{R}ⱼ if i<j (e.g. because the content item I^{R}ᵢ has a larger associated weight value than the content item I^{R}ⱼ), then the N1 content items selected from the current list of recommended content items 162 may be I^{R}₁, I^{R}₂, . . . , I^{R}_{N1}.

Similarly, the selection of the N2 content items 210 from the set associated with the selected content item I_{T} may be a random selection. However, if the set is an ordered set, the second number N2 of content items 210 that are selected from that list may be those content items 210 which occur at the start of the ordering for the set. For example, if the set associated with the selected content item I_{T} is {I^{T}₁, I^{T}₂, . . . , I^{T}ₘ} and is ordered such that I^{T}ᵢ occurs in the ordering prior to I^{T}ⱼ if i<j (e.g. because the content item I^{T}ᵢ has a larger associated weight value than the content item I^{T}ⱼ or because the content item I^{T}ᵢ is considered to be more similar, or of more interest to the user 102, than the content item I^{T}ⱼ), then the N2 content items selected from that set may be I^{T}₁, I^{T}₂, . . . , I^{T}_{N2}.

Additionally, or alternatively, the function f may select a content item 210 for inclusion in the updated list of recommended content items 162 if that content item 210 appears in both the current list of recommended content items 162 and the set of content items associated with the selected content item I_{T} (as identified by the relationship data). Thus, for example, if I^{R}ₐ=I^{T}_{b} for some 1≦a≦n and 1≦b≦n then the content item I^{R}ₐ may be included in the updated list of recommended content items 162.

As mentioned, the current or the updated list of recommended content items 162 may be ordered. The ordering for the updated list of recommended content items 162 may be based on the ordering for the N1 selected content items from the current list of recommended content items 162 and the ordering for the N2 selected content items from the set associated with the content item I_{T}. As an example, if the N1 selected content items I^{R}₁, I^{R}₂, . . . , I^{R}_{N1} and the N2 selected content items I^{T}₁, I^{T}₂, . . . , I^{T}_{N2} each have a respective weight value, then they may be ordered, within the updated list of recommended content items 162, based on those weight values (e.g. in decreasing order of weight). Alternatively, the N1 selected content items I^{R}₁, I^{R}₂, . . . , I^{R}_{N1} may be interleaved with the N2 selected content items I^{T}₁, I^{T}₂, . . . , I^{T}_{N2} (e.g. with an interleaving ratio of approximately N1:N2) with the interleaving taking content items I^{R}ᵢ in order from the current list of recommended content items 162 and the interleaving taking content items I^{T}ⱼ in order from the set associated with the selected content item I_{T}.

If the list of recommended content items 162 is ordered and includes one or more content items 210 which appear in both the current list of recommended content items 162 and the set associated with the selected content item I_{T}, the position (or index or rank) those content items in the ordering for the updated list of recommended content items 162 may be modified. As an example, the ordering of such content items may be incremented from the order in which they would otherwise be. As a further example, the ordering for the updated list of recommended content items 162 may be arranged such that those particular content items are the first (or the top/highest) items in the ordering for the list of recommended content items 162, i.e. they occur in the ordering before any other content items 210. It will be appreciated that many different ways of modifying the order of such content items may be used.

The function f may exclude duplicates from being identified in the updated list of recommended content items 162 such that the identification of each content item 210 is unique within the list.

Where the content list data 164 identifies a respective time at which that content item 210 is available to be experienced by the user 102, the function f may, additionally or alternatively, consider (or take account of or be based on) the time at which each content item 210 is available when forming the updated list of recommended content items. As an example, the function f may order the content items 210 in the updated list of recommended content items based, at least in part, on the times at which the content items 210 are available—this could be, for example, such that the higher ordered content items 210 are those that are either currently available or those that will be available sooner. Additionally or alternatively, the function f may identify the content items 210 to be included in the updated list of recommended content items 162 based, at least in part, on the times at which the content items 210 are available—this could be, for example, so that the respective times at which the content items 210 in the updated list of recommended content items 162 are available to be experienced by the user 102 are substantially evenly distributed over time. In this manner the user 102 is more likely to be provided with suitable recommendations for any particular upcoming point in time.

If the current list of recommended content items 162 is empty, then the function f may simply set the updated list of recommended content items 162 to be the set of content items 210 associated with the selected content item I_{T}, or one or more of the content items 210 in that set. For example, when initializing the receiver 150, the current list of recommended content items 162 may be initially set to be an empty list (so that n=0), so that when the list of recommended content items 162 is to be updated for the first time, the function f may then operate in this way by setting the updated list of recommended content items 162 to be the set of content items 210 associated with the selected content item I_{T}, or one or more of the content items 210 in that set.

If the selected content item I_{T} does not have an associated set of content items (or, in other words, if it has an associated set of content items but that set is empty, i.e. m=0), then the function f may set the updated list of recommended content items 162 to be the current list of recommended content items 162.

The updated list of recommended content items 162 may be formed as a separate list from the current list of recommended content items 162 in the memory 152—in this case, the current list of recommended content items 162 may then be deleted from the memory (to be replaced by the updated list of recommended content items 162) once the updated list of recommended content items 162 has been generated. Alternatively, the current list of recommended content items 162 may be modified to form the updated list of recommended content items 162 (e.g. by cancelling or adding content items to the current list of recommended content items 162).

It will be appreciated that the function f may operate in whole or in part based on one or more of the above examples, and the skilled person will appreciate that the function f may operate in different ways too. However, in summary, at the step S308, the receiver 150 forms an updated list of recommended content items 162 by referring to, or using: (a) the current list of recommended content items 162, (b) the selected content item 210 and (c) the content list data 164.

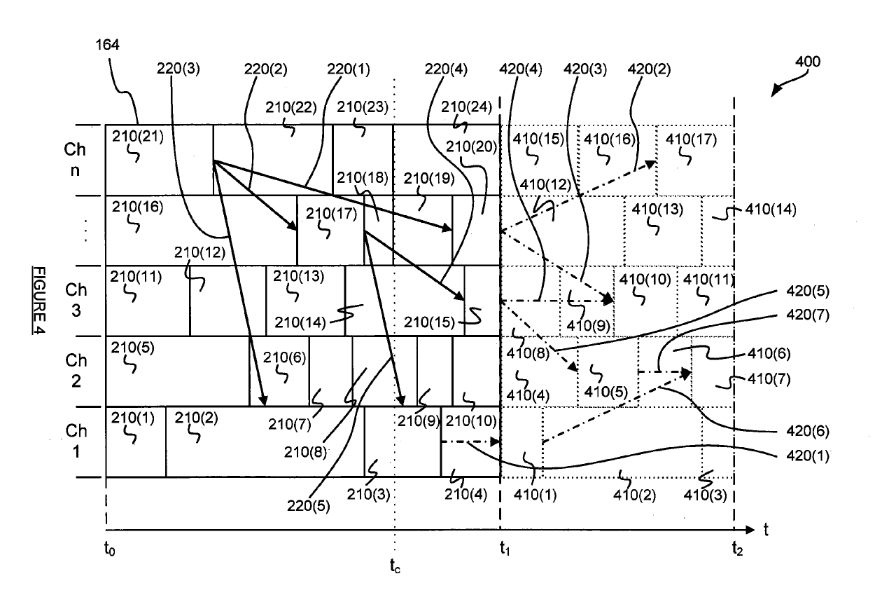

FIG. 4 schematically illustrates updated content list data 400 according to an embodiment of the invention. The updated content list data 400 is created at the receiver 150 when the receiver 150 receives content list update data from the sender 110. The content list update data identifies an update to an identified plurality of content items and/or relationship data identified by content list data 164 that the receiver 150 had previously received/generated. The content list update data is used to update the previously received content list data 164. In other words, the content list update data may represent a difference between the current content list data 164 and the intended updated content list data 400. Thus, the sender 110 need only send data to the receiver 150 indicating how to update the content list data instead of having to send an entire amount of content list data each time the content list data is to be updated. The content list data 164 received at the step S302 of FIG. 3 may, itself, be content list update data to update previously received content list data.

As will be described shortly, in some embodiments of the invention, the processor 154 may, in response to receiving an update to the content list data 164, update the current list of recommended content items based on the received update.

The updated content list data 400 may include the identification of one or more new content items 410, i.e. content items 410 not identified by previously received content list data 164.

The updated content list data 400 may include relationship data identifying one or more new relationships 420, i.e. relationships 420 not identified by previously received content list data 164. One or more of the new relationships 420 may be between new content items 410 which are also identified by the updated content list data 400, such as relationship 420(6) between content items 410(2) and 410(7). One or more of the new relationships 420 may be between a content item 210 previously identified and a newly identified content item 410, such as relationship 420(1) between content item 210(4) and 410(1). Although not illustrated, one or more of the new relationships 420 may be between existing content items 210 which were identified by the previously received content list data 164.

The updated content list data 400 might not include the identification of a number of content items 210 which were identified by the previously received content list data 164—such “legacy” content items 210 are therefore effectively “cancelled” from the memory 152 of the receiver 150.

The updated content list data 400 might not include the identification of a number of relationships 220 which were identified by the previously received content list data 164—such “legacy” relationships 220 are therefore effectively “cancelled” from the memory 152 of the receiver 150.

The various aspects and options discussed above (with respect to FIG. 2) in relation to the previously received content list data 164 are also applicable to the updated content list data 400.

Where one or more of the content items identified by the content list data 164 are associated with a point in time at which they are available, the content list data 164 may be updated such that the updated content list data 400 does not include the identification of any content items which are no longer available at the current point in time t_{c}. As an example, the updated content list data 400 might not include the identification of content item 210(1) which is no longer available at the present time t_{c}.

Similarly, when a content item 210 is no longer available at the present time t_{c}, an updated list of recommended content items 162 may be formed that does not include the identification of any content items 210 which are no longer available.

Forming an updated list of recommended content items 162 that does not include the identification of any content items 210 which are no longer available may also involve including, in the updated list of recommended content items 162, an identification of one or more content items 210 or 410 which were not identified by the previous list of recommended content items 162. The determination of one or more such content items 210 or 410 to be identified in the updated list of recommended content items 162 may be based upon one or more of: (a) the content items 210 which are no longer available, (b) the content items identified by the current list of recommended content items 162, (c) the updated content list data 400. For example:
The updated list of recommended content items may be formed by including the identification of a single content item for each content item that was previously identified by the list of recommended content items and that is no longer available.
The list of recommended content items may identify a desirable/predetermined minimum number of content items to be identified, in which case the updated list of recommended content items may be formed by including the identification of a sufficient number of content items such that at least the minimum number of content items is identified by the updated list of recommended content items. For example, suppose that the minimum number of content items is K, that the current list of recommended content items 162 identifies K+α content items (for some α≧0) and that β content items (for some β>0) are removed from the current list of recommended content items 162 when forming the updated list of recommended content items 162 (since those β content items are no longer available), then if K+α−β<K, the updated list of recommended content items 162 is formed by including at least a further β−α content items.
The selection of the content items which are to be included in the updated list of recommended content items may be selected from the set(s) of content items, identified by the relationship data, associated with the content item(s) which are no longer available. If the set(s) of content items associated with the content item(s) that are no longer available is/are ordered, the content items that are selected for inclusion in the updated list of recommend content items 164 may be the selected from the beginning of the ordering for the set(s), so that the more preferred content items are selected for the updated list of recommended content items.
If the list of recommended content items 162 is ordered, the selection of the content items may be biased to select content items from the set(s) associated with the higher ordered content item(s) in the current list of recommended content items 162 which are to be cancelled from the current list of recommended content items 162 due to no longer being available.
If the relationships have associated values representing a measure of similarity between the content items of the relationship, the selection of content items to be included in the updated list of recommended content items may be selected from the associated set(s) of content items for the or each of the content items in the current list of recommended content items 162 which are to be cancelled from the current list of recommended content items 162, selected in order of the measures of similarity.

It will be appreciated that any method of forming an updated list of recommended content items based upon one or more of (a) the content items which are no longer available, (b) the content items identified by the list of recommended content items, (c) the updated content list data, may be used. Furthermore, it will be appreciated that this method is analogous to the method of forming an updated list of recommended content items discussed in relation the step S308 of FIG. 3, with either one or more of the content items in the list of recommended content items or one or more of the content items that are no longer available being used in place of the indication/selection of a content item received from the user 102 at the step S306 of FIG. 3. Therefore the techniques discussed in relation to the step S308 of FIG. 3 can be applied analogously when updating the list of recommended content items 162 in response to receiving an update for the content list data 164.

The updating of the content list data 164 to form updated content list data 400, as well as the updating of the list of recommended content items 162 to remove content items which are no longer available and/or identify additional content items to be included in the list, may be conducted as part of the step S308, or may be conducted outside of, or separately from, the step S308 in response to any other events or periodically regardless of the occurrence of any other events, or any combination thereof.

In summary, then, content list update data can be used to form updated content list data 400. The list of recommended content items 162 may be updated such that it identifies content items which are related to the user's selections and are either currently available or available in the future. In this manner, the list of recommended content items may be kept current, even if the user 102 does not make any further selections of content items. For example, if the user 102 has not made use of the receiver 150 for some time (e.g. due to being away on holiday), then the receiver 150 can maintain an up-to-date list of recommended content items 162 ready for the next time the user 102 does actually want to make use of the receiver 150.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality and modules may be implemented as hardware and/or software. For example, the above-mentioned modules may be implemented as one or more software components for execution by a processor of the system. Alternatively, the above-mentioned modules may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method, implemented by one or more processors, of maintaining a list of recommended content items, the method comprising:
receiving content list data, the content list data identifying a plurality of content items and comprising relationship data that identifies, for each of one of more of the plurality of content items, an associated set of one or more other content items in the plurality of content items;
storing a current list of recommended content items;
receiving an identification of a content item in the plurality of content items that has been selected by a user; and
forming an updated list of recommended content items based on (a) the current list of recommended content items, (b) the selected content item and (c) the content list data.

2. The method of claim 1, in which, for each of the one of more of the plurality of content items having an associated set, the associated set is an ordered set.

3. The method of claim 2, in which, for each of the one of more of the plurality of content items having an associated set, the relationship data comprises, for each of the one or more other content items in that associated set, a respective weight, the associated set being ordered based on said weights.

4. The method of claim 3, in which the weight for a first content item in a set associated with a second content item represents a likelihood that the user will be interested in the first content item if the user is interested in the second content item.

5. The method of claim 1, in which each content item identified in the set associated with a given content item is similar to the given content item or related to the given content item.

6. The method of claim 1, in which the current list of recommended content items is an ordered list.

7. The method of claim 1, in which, for each of the one of more of the plurality of content items having an associated set, the number of content items in the associated set is at most a predetermined maximum number of content items.

8. The method of claim 1, in which the current list of recommended content items is initially an empty list, and in which forming an updated list of recommended content items comprises setting the current list of recommended content items to identify one or more of the content items identified by the set associated with the selected content item.

9. The method of claim 1, in which forming an updated list of recommended content items is based on a function of the content items in the current list of content items and the one or more content items identified by the set associated with the selected content item.

10. The method of claim 9, in which said function selects a first number of content items from the current list of content items and a second number of content items from the set associated with the selected content item.

11. The method of claim 10,
in which each content item identified in the set associated with a given content item is similar to the given content item or related to the given content item;
in which, for each of the one of more of the plurality of content items having an associated set, the associated set is an ordered set
in which the first number of content items are content items occurring at the start of the ordered current list of content items and the second number of content items are content items occurring at the start of the ordered set associated with the selected content item.

12. The method of claim 11, in which the updated list of recommended content items is ordered based on the ordering of the first number of content items from the ordered current list of content items and the ordering of the second number of content items from the ordered set associated with the selected content item.

13. The method of claim 12, in which the position, in the ordered list of recommended content items, of a content item is modified if that content item appears in both the current list of content items and the set associated with the selected content item.

14. The method of claim 9, in which said function selects a content item for inclusion in the updated list of recommended content items if that content item appears in both the current list of content items and the set associated with the selected content item.

15. The method of claim 9, in which the content item data identifies, for each content item, a respective time at which that content item is available to be experienced by the user, the updated list of recommended content items being formed in dependence upon the respective times at which the content items are available to be experienced by the user.

16. The method of claim 15, in which the function selects content items for inclusion in the updated list of recommended content items so that the respective times at which the content items in the updated list of recommended content items are available to be experienced by the user are substantially evenly distributed over time.

17. The method of claim 15, in which the function orders content items in the updated list of recommended content items in dependence upon the respective times at which the content items in the updated list of recommended content items are available to be experienced by the user.

18. The method of claim 1, in which the content list data identifies an update to an identified plurality of content items and/or relationship data identified by previously received content list data, the method comprising updating the identified plurality of content items and/or relationship data based on the update.

19. The method of claim 1, comprising:
receiving an update to the identified plurality of content items and/or to the relationship data; and
in response to receiving the update, updating the current list of recommended content items based on the received update.

20. An apparatus comprising one or more processors arranged to:
receive content list data, the content list data identifying a plurality of content items and comprising relationship data that identifies, for each of one of more of the plurality of content items, an associated set of one or more other content items in the plurality of content items;
store a current list of recommended content items;
receive an identification of a content item in the plurality of content items that has been selected by a user; and
form an updated list of recommended content items based on (a) the current list of recommended content items, (b) the selected content item and (c) the content list data.

21. (canceled)

22. (canceled)

23. The apparatus of claim 20, in which, for each of the one of more of the plurality of content items having an associated set, the associated set is an ordered set.

24. The apparatus of claim 23, in which, for each of the one of more of the plurality of content items having an associated set, the relationship data comprises, for each of the one or more other content items in that associated set, a respective weight, the associated set being ordered based on said weights.

25. The apparatus of claim 24, in which the weight for a first content item in a set associated with a second content item represents a likelihood that the user will be interested in the first content item if the user is interested in the second content item.

26. The apparatus of claim 20, in which each content item identified in the set associated with a given content item is similar to the given content item or related to the given content item.

27. The apparatus of claim 20, in which the current list of recommended content items is an ordered list.

28. The apparatus of claim 20, in which, for each of the one of more of the plurality of content items having an associated set, the number of content items in the associated set is at most a predetermined maximum number of content items.

29. The apparatus of claim 20, in which the current list of recommended content items is initially an empty list, and in which the one or more processors are arranged to form the updated list of recommended content items by setting the current list of recommended content items to identify one or more of the content items identified by the set associated with the selected content item.

30. The apparatus of claim 20, in which the one or more processors are arranged to form the updated list of recommended content items based on a function of the content items in the current list of content items and the one or more content items identified by the set associated with the selected content item.

31. The apparatus of claim 30, in which said function selects a first number of content items from the current list of content items and a second number of content items from the set associated with the selected content item.

32. The apparatus of claim 31,
in which each content item identified in the set associated with a given content item is similar to the given content item or related to the given content item;
in which, for each of the one of more of the plurality of content items having an associated set, the associated set is an ordered set
in which the first number of content items are content items occurring at the start of the ordered current list of content items and the second number of content items are content items occurring at the start of the ordered set associated with the selected content item.

33. The apparatus of claim 32, in which the updated list of recommended content items is ordered based on the ordering of the first number of content items from the ordered current list of content items and the ordering of the second number of content items from the ordered set associated with the selected content item.

34. The apparatus of claim 33, in which the position, in the ordered list of recommended content items, of a content item is modified if that content item appears in both the current list of content items and the set associated with the selected content item.

35. The apparatus of claim 30, in which said function selects a content item for inclusion in the updated list of recommended content items if that content item appears in both the current list of content items and the set associated with the selected content item.

36. The apparatus of claim 30, in which the content item data identifies, for each content item, a respective time at which that content item is available to be experienced by the user, the one or more processors being arranged to form the updated list of recommended content items in dependence upon the respective times at which the content items are available to be experienced by the user.

37. The apparatus of claim 36, in which the function selects content items for inclusion in the updated list of recommended content items so that the respective times at which the content items in the updated list of recommended content items are available to be experienced by the user are substantially evenly distributed over time.

38. The apparatus of claim 36, in which the function orders content items in the updated list of recommended content items in dependence upon the respective times at which the content items in the updated list of recommended content items are available to be experienced by the user.

39. The apparatus of claim 20, in which the content list data identifies an update to an identified plurality of content items and/or relationship data identified by previously received content list data, the one or more processors being arranged to update the identified plurality of content items and/or relationship data based on the update.

40. The apparatus of claim 20, in which the one or more processors are arranged to:
receive an update to the identified plurality of content items and/or to the relationship data; and
in response to receiving the update, update the current list of recommended content items based on the received update.

41. A tangible non-transitory computer readable medium storing a computer program which, when executed by one or more processors, causes the one or more processors to carry out a method of maintaining a list of recommended content items, the method comprising:
receiving content list data, the content list data identifying a plurality of content items and comprising relationship data that identifies, for each of one of more of the plurality of content items, an associated set of one or more other content items in the plurality of content items;
storing a current list of recommended content items;
receiving an identification of a content item in the plurality of content items that has been selected by a user; and
forming an updated list of recommended content items based on (a) the current list of recommended content items, (b) the selected content item and (c) the content list data.
